(19) United States
(12) Patent Application Publication
(10) Pub. No.: US 2005/0225412 A1
(43) Pub. Date: Oct. 13, 2005

(54) Microelectromechanical switch with an arc reduction environment

(76) Inventor: Naomi O. Limcangco, Quezon City (PH)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/816,402

(22) Filed: Mar. 31, 2004

(51) Int. Cl. G02B 6/26

(52) U.S. Cl. 335/78

(57) ABSTRACT

Embodiments of the present invention include an apparatus, a method, and a system for a microelectromechanical switch with an arc reduction environment.

### FIELD

Disclosed embodiments of the present invention relate to the field of microelectromechanical systems (MEMS), and in particular to MEMS switches with an arc reduction environment.

### BACKGROUND

A microelectromechanical system (MEMS) is a microdevice that integrates mechanical and electrical elements on a common substrate using microfabrication technology. The electrical elements are typically formed using integrated circuit fabrication techniques, while the mechanical elements are typically fabricated using lithographic techniques that selectively micromachine portions of the substrate. Additional layers are often added to the substrate and then micromachined until the MEMS device is in a desired configuration. MEMS devices include actuators, sensors, switches, accelerometers, and modulators.

One type of MEMS switch includes a suspended connecting member, or beam, that is electrostatically deflected by energizing an actuation electrode. The deflected beam includes one or more protuberances that engage one or more electrical contacts to establish one or more electrical connections between isolated contacts. A beam anchored at one end while suspended over a contact at the other end is often called a cantilevered beam. A beam anchored at opposite ends and suspended over one or more electrical contacts is often called a bridge beam. A cap is often placed over the switch components to isolate them from unwanted foreign materials.

One issue that arises with current MEMS switches is that when the switch is operated at high power there is a tendency for an environment immediately surrounding the switch to become conductive, leading to the formation of an arc between the protuberance and the signal contact. This arc may raise the temperature of the protuberance and the signal contact to a point where the materials melt. Thus, when the switch is activated the protuberance and the signal will contact each other and weld together, thereby decreasing the life of the switch.

### BRIEF DESCRIPTION OF THE DRAWINGS

Embodiments of the invention are illustrated by way of example and not by way of limitation in the figures of the accompanying drawings, in which the like references indicate similar elements and in which:

FIG. 1 illustrates a side view of a microelectromechanical system (MEMS) switch with an arc reduction environment, in accordance with an embodiment of the present invention;

FIG. 2 illustrates a side view of the MEMS switch with the beam deflected towards a pair of actuation electrodes, in accordance with an embodiment of the present invention;

FIG. 3 illustrates a top view of the MEMS switch with a signal voltage flowing through signal lines, in accordance with an embodiment of the present invention;

FIG. 4 illustrates a flow chart of the MEMS switch operating with a hydride coating, in accordance with an embodiment of the present invention;

FIGS. 5a-5d illustrate several coating schemes in accordance with various embodiments of the present invention;

FIG. 6 illustrates the coating being placed as a dimple on the beam of the MEMS switch, in accordance with an embodiment of the present invention; and

FIG. 7 illustrates a block diagram of an electronic system incorporating at least one MEMS switch, in accordance with an embodiment of the present invention.

### DETAILED DESCRIPTION OF EMBODIMENTS OF THE INVENTION

In the following detailed description, reference is made to the accompanying drawings that form a part hereof, wherein like numerals designate like parts throughout, and in which is shown, by way of illustration, specific embodiments in which the invention may be practiced. It is to be understood that other embodiments may be utilized and structural or logical changes may be made without departing from the scope of the embodiments of the present invention. Therefore, the following detailed description is not to be taken in a limiting sense and the scope of the embodiments of the present invention is defined by the appended claims and their equivalents.

Various operations will be described as multiple discrete operations in turn, in a manner that is most helpful in understanding the embodiments; however, the order of description should not be construed to imply that these operations are necessarily order dependent. In particular, these operations need not be performed in the order of presentation.

The phrase “in one embodiment” is used repeatedly. The phrase generally does not refer to the same embodiment, however, it may. The terms “comprising,” “having,” and including” are synonymous, unless the context dictates otherwise.

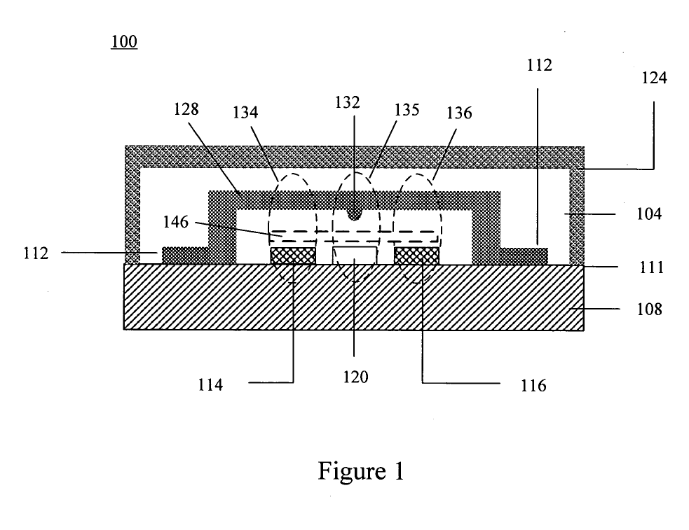

FIG. 1 illustrates a microelectromechanical system (MEMS) switch 100 with an arc reduction environment 104, in accordance with an embodiment of this invention. The MEMS switch 100 includes a substrate 108 with an upper surface 111. The substrate 108 may be part of a chip or any other electronic device. The substrate 108 may be a nonconductive material that holds other components including, but not limited to, anchors 112, actuation electrodes 114 and 116, signal contact 120, and a cap 124. The actuation electrodes 114 and 116 and the signal contact 120 may be electrically coupled to other electronic components via conducting traces in the substrate 108 (not shown), or through other means. The actuation electrodes 114 and 116 and the signal contact 120 may be coupled to different voltage power sources. The cap 124 may be made of an insulating material and may define a portion of the boundaries of the environment 104. The environment 104 may be largely free of foreign materials and debris, and may imitate some of the characteristics of a vacuum. A coating 146 may be placed at some point in the environment 104 to at least facilitate the existence of an arc reduction environment, to be discussed further below.

In one embodiment, the switch 100 may further include a bridge beam 128 having a flexible portion supported at both ends.by the anchors 112. It should be noted that in alternative embodiments, the beam 128 may be suspended over the signal contact 120 in a cantilevered fashion. The beam 128 may be suspended such that there is a gap between the actuation electrodes 114 and 116 and the beam 128. The gap may be sized so that the actuation electrodes 114 and 116 are in electrostatic communication with corresponding portions of the beams called beam electrodes. The actuation electrodes 114 and 116 and the corresponding beam electrodes may be referred to as actuation electrode pairs 134 and 136. The beam 128 may also be suspended such that there is a gap in between the signal contact 120 and another beam electrode. The signal contact 120 and the corresponding beam electrode may be referred to as the signal electrode pair 135. In this embodiment, the coating 146 may be located at some point between at least one of the electrode pairs 134,135, and 136. However, other embodiments may include the coating placed in other locations, e.g., on the inside surface of the cap 124.

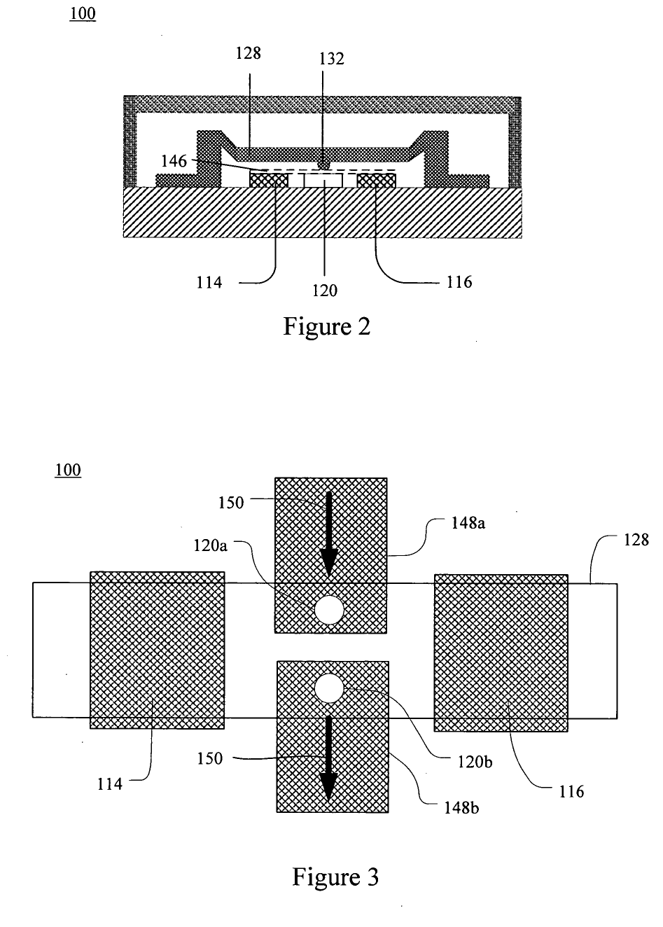

In one embodiment, the MEMS switch 100 may be in an “on” state when an actuating voltage is applied to the actuation electrodes 114 and 116. In one embodiment the actuating voltage may be a direct current (DC) voltage. The actuating voltage may create an attractive electrostatic force between the actuation electrodes 114 and 116 and the beam 128 that deflects the beam 128 downward. See FIG. 2. The beam 128 may move toward the actuation electrodes 114 and 116 until a protuberance 132 electrically couples the beam 128 with the signal contact 120. The protuberance 132 may be a conductive protrusion on the beam electrode corresponding to the signal contact 120. In one embodiment the protuberance 132 may prevent the beam 128 from coming in contact with the actuation electrodes 114 and 116 when the switch is in an “on” position, thereby avoiding a short circuit. In various embodiments, the beam 128 may electrically couple the signal contact 120 without the protuberance 132.

In one embodiment, the beam 128 may be made of a purely conductive material. In another embodiment the beam 128 may be made of an insulative material coated with a conductive material. The beam 128 may be resilient enough to withstand continuous bending and unbending during activation of the MEMS switch 100, for a target operational life of the switch 100.

FIG. 3 illustrates a top view of the MEMS switch 100, in accordance with an embodiment of this invention. When the actuating voltage is applied to the actuation electrodes 114 and 116, the beam 128 may electrically couple together a pair of signal lines 148a and 148b through an input signal contact 120a and an output signal contact 120b, such that a signal voltage 150 may be transmitted. In one embodiment the signal voltage 150 may be a radio frequency (RF) electrical signal.

In another embodiment, the signal lines 148* (where asterisk may be “a” or “b”) may be electrically coupled to one another such that the beam 128 acts as a shunt when it engages the signal contacts 120*.

In various embodiments the number and orientation of the signal lines 148* (along with the respective signal contacts 120*), the actuation electrodes 114 and 116, and the protuberances may change without departing from the scope of embodiments of this invention. For example, one embodiment could embed one or more actuation electrodes into the substrate 108, while keeping the signal lines 148* on the surface.

A prior art environment may contain a number of primary electrons in between the electrodes. An electric field created between the electrodes may cause the primary electrons to collide with, and dislodge secondary electrons from, the uncoated electrodes. As more and more electrons are dislodged from the electrodes into the environment, the environment may become more conducive to an arc because of the increased concentration of electrons between the electrodes. An arc would further exacerbate the situation by increasing the number of collisions of the primary electrons with the electrodes, thereby releasing more secondary electrons. This type of reaction may sometimes be referred to as multipaction. Arcing due to multipactoring may be one of the factors limiting the power capacities of present MEMS switches.

To at least facilitate the reduction of multipactoring, one embodiment of the present invention employs a coating 146 having a coefficient of secondary electron emission lower than the electrode over which it is placed. The coating 146 may be more resistant to this secondary electron emission than the underlying electrode, which may result in the environment being less conducive to arcing between the beam 128 and the signal contact 120 because of a lower concentration of electrons in the environment 104. Said another way, placing a coating 146 having a relatively low coefficient of secondary electron emission over at least one electrode may at least facilitate the existence of an arc reduction environment by suppressing the charge multiplication within the environment. In one embodiment, this coating may include, e.g., titanium or a titanium nitride. However, other coating materials having relatively low coefficients of secondary electron emission may be additionally or alternatively employed in various embodiments.

In one embodiment, placing a layer of the coating 146 over the electrode may allow the electrode to be constructed of other materials, better suited for other design constraints. For example, in one embodiment the beam may be constructed of a resilient material, e.g., gold, in order to withstand the repetitive bending from the MEMS switch 100 being turned on and off. Placing a layer of the coating 146, e.g., titanium, over this resilient material, may at least facilitate the existence of an arc reduction environment without sacrificing the resiliency of the beam 128.

In one embodiment, the coating 146 may be comprised of a hydride material, which may at least facilitate the existence of an arc reduction environment by increasing the pressure within the cap 124. A hydride material may be a compound in Which hydrogen is bonded chemically to a metal, metalloid, or alloy. This bonding may be reversible such that the hydrogen stored in the compound may be desorbed into the environment under certain atmospheric conditions, e.g., temperature and pressure.

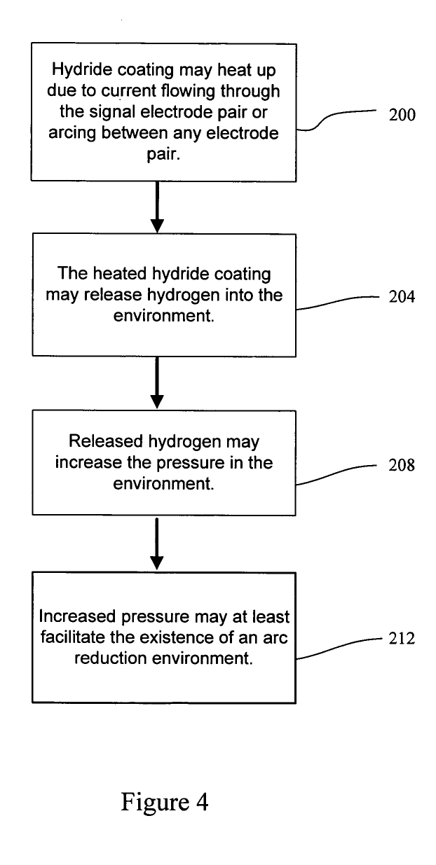

FIG. 4 illustrates a flowchart of the MEMS switch 100 operating with a hydride coating, in accordance with an embodiment of this invention. The hydride coating may become heated due to current flowing through the signal electrode pair and/or arcing between any of the electrode pairs 200. The heated hydride coating may release hydrogen into the environment 204. The released hydrogen may increase the pressure of the environment 208. This high-pressure environment may either extinguish an existing arc or prevent an arc from forming, thereby at least facilitating the existence of an arc reduction environment 212.

The amount and type of hydride material to be applied as a coating may be selected based, at least in part, on the material's absorption and desorption rates occurring at particular atmospheric conditions. Additional factors to be considered may include, but are not limited to, the pressure needed for an effective arc reduction environment, the area of the environment, the placement of the coating, the actuating and signal voltage levels, the types of conductors used in the electrodes, and the concentration of primary electrons in the environment. Examples of hydrides may include, but are not limited to, a nickel hydride, a magnesium hydride, an iron hydride, a palladium hydride, and a titanium hydride.

In various embodiments, the coating 146 may be a hydride that also has a relatively low coefficient of secondary electron emission. Various embodiments may also include a hydride placed on certain surfaces and a coating with a relatively low coefficient of electron emission placed on other surfaces.

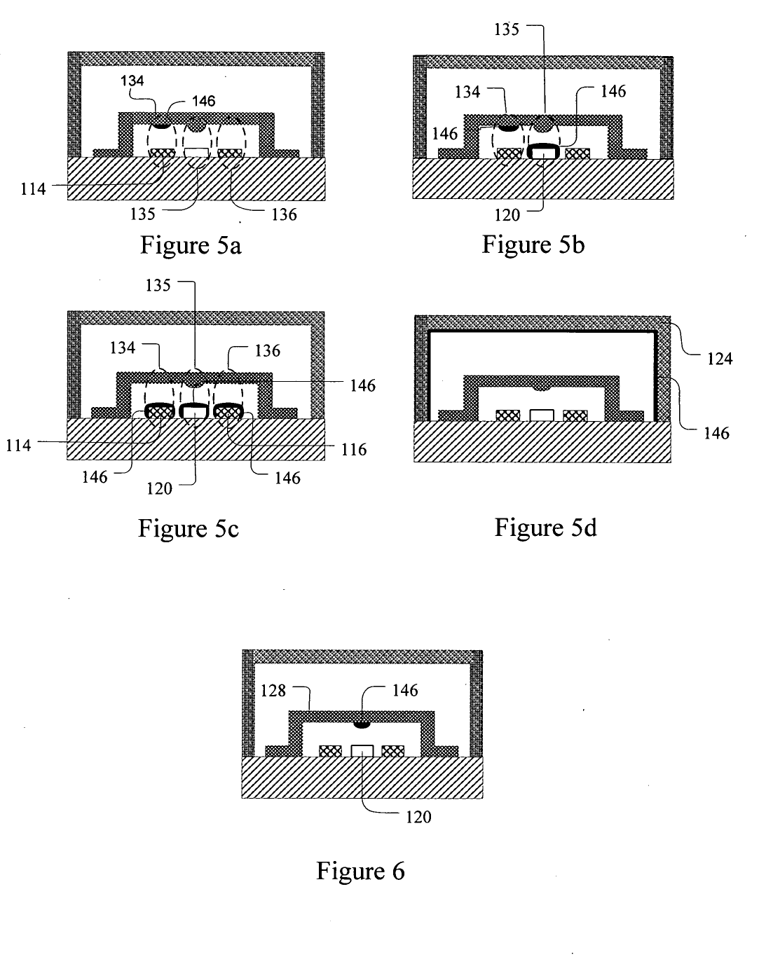

FIG. 5 illustrates several coating schemes in accordance with various embodiments of the present invention. FIG. 5a illustrates the coating 146 being disposed between the electrodes of only one of the electrode pairs. Specifically, the coating 146 is applied to the beam electrode of the first actuation electrode pair 134. In various embodiments, either of the other two electrode pairs 135 or 136 may have the coating 146. In various embodiments, the coating 134 may be applied to either or both of the electrodes of the electrode pair 134. For example, various embodiments could include the coating 146 being applied to the actuation electrode 114 only or applied to both the beam electrode and the actuation electrode 114.

FIG. 5b illustrates the coating 146 being disposed between the electrodes of two electrode pairs 134 and 135, in accordance with an embodiment of this invention. FIG. 5b illustrates one electrode of each electrode pair 134 and 135 being coated with the coating 146. Specifically, the beam electrode is coated in the first actuation electrode pair 134 and the signal contact 120 is coated in the signal electrode pair 135. However, in various embodiments, either or both of the electrodes of the electrode pairs 134 and 135 may be coated with the coating 146. Additionally, in one embodiment, the other actuation electrode pair may have a coating disposed between its electrodes.

FIG. 5c illustrates an embodiment having the coating 146 disposed between each of the electrode pairs 134, 135, and 136. Specifically, the coating 146 is applied to the actuation electrodes 114 and 116 and the signal contact 120. In various embodiments, the beam electrodes may be additionally or alternatively coated in each of the electrode pairs 134, 135, and 136. Various embodiments may include a different number of electrode pairs with the coating scheme being adjusted to accommodate the design considerations of the particular embodiment.

FIG. 5d illustrates the coating 146 being applied to the inside surface of the cap 124, in accordance with one embodiment of the invention. Applying the coating 146 to the cap 124 may facilitate the application and allow for the coating step to be done at a number of different times in the process. The coating schemes illustrated in the embodiments of FIG. 5 represent only some of the many possible coating schemes available to embodiments of the present invention, other coating schemes may be used in other embodiments.

FIG. 6 illustrates an embodiment of the present invention wherein the coating 146 is placed as a dimple on the portion of the beam 128 corresponding to the signal contact 120. In this embodiment, the coating 146 may serve similar functions as the protuberance 132 discussed with reference to above embodiments.

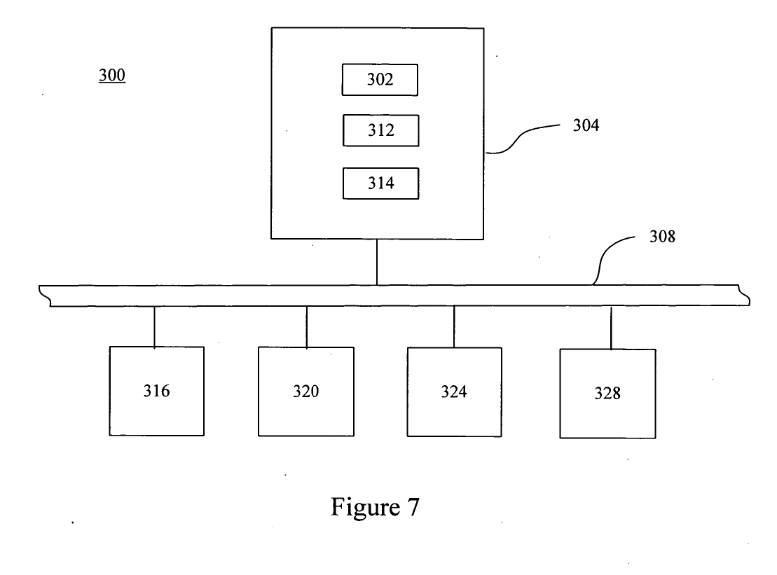

FIG. 7 illustrates a block diagram of an electronic system 300 of one embodiment incorporating at least one MEMS switch 302, similar to MEMS switch 100 illustrated in FIGS. 1-6. The MEMS switch 302 may form a part of a circuit 304 that is coupled to a bus 308. In one embodiment, the circuit 304 may include a processor 312, which can be of any type. As used herein, processor means any type of circuit such as, but not limited to, a microprocessor, a graphics processor, and a digital signal processor.

Other types of circuits that can be included in the circuit 304 are a custom circuit or an application-specific integrated circuit, such as communications circuit 314 for use in wireless devices.

The electronic system 300 may also include a main memory 316, a graphics processor 320, a mass storage device 324, and an input/output module 328 coupled to each other by way of the bus 308, as shown. Examples of the memory 316 include, but are not limited to, static random access memory (SRAM) and dynamic random access memory (DRAM). Examples of the mass storage device 324 include, but are not limited to, a hard disk drive, a compact disk drive (CD), a digital versatile disk drive (DVD), and so forth. Examples of the input/output module 328 include, but are not limited to, a keyboard, a cursor control device, a display, a network interface, and so forth. Examples of the bus 308 include, but are not limited to, a peripheral control interface (PCI) bus, and an industry standard architecture (ISA) bus, and so forth. In various embodiments, the system 300 may be a wireless mobile phone, a personal digital assistant, a network router, a tester, a sensor, and a server.

MEMS switch 302 can be implemented in a number of different forms, including an electronic package, an electronic system, a computer system, one or more methods of fabricating an electronic package, and one or more methods of fabricating a circuit that includes the package.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiment shown and described without departing from the scope of the present invention. For example, while the above embodiments describe a MEMS switch, the invention is not so limited, and may be practiced at other scales, e.g., nanoscale. Those with skill in the art will readily appreciate that the present invention may be implemented in a very wide variety of embodiments. This application is intended to cover any adaptations or variations of the embodiments discussed herein. Therefore, it is manifestly intended that embodiments of this invention be limited only by the claims and the equivalents thereof.

1. An electromechanical switch comprising:
a signal contact;
an actuation electrode;
a beam to electrically couple to the signal contact when an actuating voltage is applied to the actuation electrode; and
a coating to at least facilitate the existence of an arc reduction environment.

2. The electromechanical switch of claim 1, further comprising:
a cap coupled to a substrate to substantially enclose the signal contact, the actuation electrode, the beam, and the coating; and
the cap and the substrate cooperate to define the boundaries of the arc reduction environment.

3. The electromechanical switch of claim 1, wherein the coating comprises a hydride.

4. The electromechanical switch of claim 1, wherein the coating is disposed between the beam and at least one of a group consisting of the signal contact and the actuation electrode.

5. The electromechanical switch of claim 4, wherein the coating is applied to at least one of a group consisting of the actuation electrode, the signal contact, a first portion of the beam corresponding to the actuation electrode, and a second portion of the beam corresponding to the signal contact.

6. The electromechanical switch of claim 5, wherein
the signal contact, the actuation electrode, and the beam are comprised of respective materials having respective coefficients of secondary electron emissions, and
the coating is comprised of a material having a coefficient of secondary electron emission approximately lower than the coefficients of secondary electron emissions of the material over which it is applied.

7. The electromechanical switch of claim 6, wherein the coating includes titanium.

8. The electromechanical switch of claim 1, further comprising:
a protuberance disposed on a portion of the beam corresponding to the signal contact.

9. The electromechanical switch of claim 8, wherein at least a portion of the coating is applied to the protuberance.

10. The electromechanical switch of claim 8, wherein at least a portion of the coating comprises the protuberance.

11.-17. (canceled)

18. A system comprising:
a bus;
a memory coupled to the bus; and
a circuit coupled to the bus, the circuit including an electromechanical switch having a signal contact, an actuation electrode, a beam to engage the signal contact when a voltage is applied to the actuation electrode, and a coating to facilitate the existence of an arc reduction environment.

19. The system of claim 18, wherein the coating comprises a hydride.

20. The system of claim 18, wherein the coating is applied to at least one of a group consisting of the actuation electrode, the signal contact, a first portion of the beam corresponding to the actuation electrode, and a second portion of the beam corresponding to the signal contact.

21. The system of claim 20, wherein
the signal contact, the actuation electrode, and the beam are comprised of respective materials having respective coefficients of secondary electron emissions; and
the coating is comprised of a material having a coefficient of secondary electron emission lower than the coefficients of secondary electron emissions of the material over which it is applied.

22. The system of claim 21, wherein the coating includes titanium.

23. The system of claim 18, wherein the circuit further includes a processor.

24. The system of claim 23, wherein the system is a selected one of a group consisting of a network router, a wireless mobile phone, and a personal digital assistant.

25. A method comprising:
transmitting a signal to an input of an enclosed switch having a beam, a signal contact and an actuation electrode selectively actuatable to couple the beam to the signal contact, the enclosed switch further having a coating to reduce a likelihood of a generation of an arc within the enclosed switch; and
applying an actuating voltage to the actuation electrode to couple the beam to the signal contact.

26. The method of claim 25, wherein the coating comprises a hydride and applying an actuating voltage heats the hydride coating to a point that hydrogen is released, the released hydrogen increasing a pressure within the enclosed switch.

27. The method of claim 25, further comprising:
transmitting the signal to an output of the enclosed switch when the beam is coupled to the signal contact.

28. The method of claim 25, wherein the coating is applied to at least one of a group consisting of the actuation electrode, the signal contact, a first portion of the beam corresponding to the actuation electrode, and a second portion of the beam corresponding to the signal contact.

29. The method of claim 25, wherein
the signal contact, the actuation electrode, and the beam are comprised of respective materials having respective coefficients of secondary electron emissions; and
the coating is comprised of a material having a coefficient of secondary electron emission lower than the coefficients of secondary electron emissions of the material over which it is applied.

30. The method of claim 25, wherein the coating includes titanium.
